(19) United States
(12) Patent Application Publication
(10) Pub. No.: US 2003/0048937 A1
(43) Pub. Date: Mar. 13, 2003

(54) Method of processing visual imagery from a medical imaging device

(75) Inventors: Grant T. Gullberg, El Cenito, CA (US); Arkadiusz Sitek, Framingham, MA (US)

Correspondence Address: Lloyd W. Sadler, Parsons Behle & Latimer, Suite 1800, 201 South Main Street, Salt Lake City, UT, 84111, US

(73) Assignee: University of Utah, Salt Lake City, UT

(21) Appl. No.: 10/121,832

(22) Filed: Apr. 11, 2002

Related U.S. Application Data
(60) Provisional application No. 60/283,104, filed on Apr. 11, 2001.

(51) Int. Cl. G06K 9/00

(52) U.S. Cl. 382/131; 382/154

(57) ABSTRACT

A method for using factor analysis to improve the resolution and remove undesired biological activity from medical device imagery employs a Penalized Least Squares Factor Analysis of Dynamic Structures technique. Non-uniqueness correction is provided, based on minimizing the overlaps between images of different factor coefficient images. This invention finds application in the image processing of the full range of medical imaging devices and systems.

### CROSS REFERENCE TO RELATED APPLICATION

This application claims priority to prior, co-owned and co-pending U.S. Provisional Patent Application No. 60/283,104 for all common material.

### FEDERAL RESEARCH STATEMENT

This invention was partially funded by U.S. NIH grant number RO1 HL 50663.

### BACKGROUND OF INVENTION

1. Field of the Invention

This invention relates to methods for processing visual image data. More specifically, this invention relates to methods of enhancing image data and resolution collected from medical imaging devices.

2. Description of Related Art

A variety of image processing techniques are well known in the art. Generally, these methods do not provide for the removal of specific selected biological activity from the IMAGERY to thereby enhance the visualization of other biological processes. Moreover, such prior methods tend not to be adapted to the specific requirements of medical imaging devices and technology.

Although these documents are not necessarily prior art to this invention, the reader is referred to the following publications for general background material. Each of these documents is hereby incorporated by reference in its entirety for the material contained therein.

Review of Physiological and Anatomical Factors Impacting Count Uniformity in Attenuation and Scatter Corrected Tc-99m Sestamibi SPECT Slices, P. H. Pretorius et al., Journal of Nuclear Medicine, vol. 40 no. 5, 1999.

Imaging Synaptic Neurotransmission with in vivo Binding Competition Techniques: A Critical Review, M. Laruelle, Journal of Cerebral Blood Flow and Metabolism, vol. 20 no. 3, 2000.

Factor Analysis with a priori Knowledge—Application in Dynamic Cardiac SPECT, A. Sitek, E. V. R. Di Bella and G. T. Gullberg, Journal of Physics in Medicine and Biology 45, 2619-2638, 2000.

The Development of Nuclear Medicine in Finland: A review on the Occasion of the 40th Anniversary of the Finnish Society of Nuclear Medicine, K. Liewendahl et al, Clinical Physiology, vol. 20 no. 5, 2002.

Removal of Liver Activity Contamination in Teboroxime Dynamic Cardiac SPECT imaging with the Use of Factor Analysis, Arkadiusz Sitek, Edward V. R. Di Bella, Grant T. Gullberg and Ronald H. Huesman, Journal of Nuclear Cardiology, 2002.

EPO Patent Application Publication No. 1181936, entitled Synthesis, Biological and Preclinical Evaluation of (D-Phe6, Leu-NHEt13, des-Met14) Bombesin (6-14) Analogs Modified with 1,4,8,11-Tetraazanundecane Derivatives and Labeled with Technetium-99m for Applications in Oncology SPECT in the Field of Neurology, M. B. Mondol et al., Bangladesh Med. Res. Coune Bull, vol. 26, December 2000.

Effect of Motion on Cardiac SPECT Imaging: Recognition and Motion Correction, J. Fitzgerald et al., J. Nuclear Cardiology, November-December 2001.

Brain SPECT of Dopaminergic Neurotransmission: a New Tool with Proved Clinical Impact, A. M. Catafau, Nuclear Medicine Communication, vol. 22 no. October 10, 2001.

High Resolution SPECT in Small Animal Research, A. Wirrwar et al., Rev. Neuroscience, vol. 12, 2001.

Intralobar Bronchopulmonary Sequestration: Evidence of Air Trapping Shown by Dynamic Xenon-133, K. Suga et al., Br. J. Radiology, vol. 74 no. 883, July 2001.

Bone Scintigraphy and the Added Value of SPECT (Single Photon emission Tomography) in Detecting Skeletal Lesions, G. Savelli et al., Q. J. Nuclear Medicine, vol. 45, March 2001.

An Introduction to PET and SPECT Neuroreceptor Quantification Models, M. Ichise et al., J. Nuclear Medicine, vol. 42, May 2001.

Brain SPECT in Neurology and Psychiatry, E. E. Camargo, J. Nuclear Medicine, vol 42, April 2001.

Fluorine-18-Deoxyglucose SPECT and Coincidence Imaging for Myocardial Viability: Clinical and Technologic Issues, V. Dilsizian et al., J. Nuclear Cardiology, January-February 2001.

SPECT in Neocortical Epilepsies, V. M. Thadani et al., Advanced Neurology, vol. 84, 2000.

Molecular Imaging in Vivo with PET and SPECT, G. D. Luker et al., Academy of Radiology, January 2001.

Bone SPECT of the Knees, P. J. Ryan, Nuclear Medicine Communications, vol. 21 no. October 10, 2000.

High Resolution PET, SPECT and Projection Imaging in Small Animals, M. V. Green et al., Computation Medical Imaging Graphics, vol. 25, March-April 2001.

Image-Correction Techniques in SPECT, L. Bouwens et al., Computation Medical Imaging Graphics, vol. 25, March-April 2001.

Anatomy of a Meta-Analysis: a Critical Review of “Exercise Echocardiography or Exercise SPECT Imaging? A Meta-Analysis of Diagnostic Test Performance”, S. M. Kymes et al., J. Nuclear Cardiology, November-December 2000.

SPECT and PET Imaging of the Dopaminergic System in Parkenson's Disease, T. Brucke et al., J. Neurology, vol. 247, September 2000.

Modeling of Receptor Ligand Data in PET and SPECT Imaging: a Review of Major Approaches, J. H. Meyer et al., J. Neuroimaging, vol. 11, January 2001.

Single-Photon Emission Computed Tomography (SPECT) in Childhood Epilepsy, S. Gulati et al., Indian J. Pediatrics, vol. 67 no. 1 January 2000.

Neuropharmacological Studies with SPECT in Neuropsychiatric Disorders, A. Heinz et al., Nuclear Medical Biology, vol. 27, October 2000.

Advances in Nuclear Emission PET and SPECT Imaging, E. V. Garcia et al., IEEE Eng. Medical Biology Magazine, vol. 19, September-October 2000.

GE Medical Systems and Amersham Health Establish Broad Research Collaboration, no author, Business Wire, Nov. 27, 2001.

Peregrine Announces Image Fusion Data from Phase II Cotara Trial; Data to be Presented at the Meeting of the World Federation of Neuro-Oncology, no author, Business Wire, Nov. 16, 2001.

BIOMEC Receives Phase II Small Business Innovation Research Grant from NIH, no author, Newswire, Aug. 07, 2001.

Siemens Showcases Best Practice Integration Technologies in Nuclear and PET Imaging at the SNM Annual Meeting, no author, Business Wire, Jun. 24, 2001.

Siemens Introduces M.CAM Nuclear Camera; Meeting Stringent Sensitivity Resolution Requirements of Small Animal Imaging, no author, Business Wire, Jul. 24, 2001.

The Use of Principal Components in the Quantitative Analysis of Gamma Dynamic Studies, D. C. Barber, Phys. Med. Biology, vol. 25, 1980.

Handling of Dynamic Sequences in Nuclear Medicine, R. Di Paola et al., IEEE Trans. Nucl. Science, vol. NS-43, 1982.

Spectral Analysis of Dynamic PET Studies, V. J. Cunningham et al., J. Cereb. Blood Flow and Metab., vol. 13, 1993.

Imaging Radiotracer Model Parameters in PET: a Mixture Analysis Approach, IEEE Trans. Med. Imag., vol. 12, 1993.

Mixture Analysis of Multichannel Image Data, R. K. Choudhury, Univ. of Washington, 1998.

The Effect of Apex-Finding Errors on Factor Images Obtained from Factor Analysis and Oblique Transformation, A. S. Houston, Phys. Med. Biol., vol. 29, 1984.

Target, Apex-Seeing in Factor Analysis on Medical Sequences, I. Buvat et al., Phys. Med. Biol., vol. 38, 1993.

Factor Analysis of Dynamic Function Studies using a priori Physiological Information, K. S. Nirjan et al., Phys. Med. Biol., vol. 31, 1986.

The Importance of Constraints in Factor Analysis of Dynamic Studies, K. S. Nirjan et al., Information Processing in Medical Imaging, 1988.

Rotation to Simple Structure in Factor Analysis of Dynamic Radionuclide Studies, M. Samal et al., Phys. Med. Biol., vol. 32, 1989.

The Use of Set Theory and Cluster Analysis to Investigate the Constraint Problem in Factor Analysis in Dynamic Structures (FADS), A. S. Houston, Information Processing in Medical Imaging, 1986.

A Method for Recovering Physiological Components from Dynamic Radionuclide Images Using the Maximum Entropy Principle: a Numerical Investigation, M. Nakamura et al., IEEE Trans. Biomed. Eng., vol. 36, 1989.

Factor Analysis in Dynamic Structures in Dynamic SPECT using Maximum Entropy, A. Sitek et al., IEEE Trans. Nucl. Sci., vol. 46, 1999.

Numerical Recipes in C, W. H. Press et al., Cambridge University Press, 1996.

Evaluation of Cardiac Cone-Beam SPECT Using Observer Performance Experiments and ROC Analysis, B. M. W. Tsui et al., Inv. Radiol., vol. 28, 1993.

U.S. Pat. No. 6,362,479, entitled Scintillation Detector Array for Encoding the Energy, Position, and Time Coordinates of Gamma Ray Interactions.

U.S. Pat. No. 6,236,050, entitled Method and Apparatus for Radiation Detection.

U.S. Pat. No. 6,194,728, entitled Imaging Detector for Universal Nuclear Medicine Imager.

U.S. Pat. No. 6,147,352, entitled Low Profile Open Ring Single Photon Emission Computed Tomographic Imager.

U.S. Pat. No. 6,040,580, entitled Method and Apparatus for Forming Multi-Dimensional Attenuation Correction Data in Tomography.

PCT WO Publication No. 00212918, entitled SPECT Gamma Cameral.

PCT WO Publication No. 00207600, entitled Test Body and Test Body Systems, Production and Use Thereof.

PCT WO Publication No. 00182978, entitled Imaging of Nicotinic Acetylcholine Receptor Subtypes.

PCT WO Publication No. 00156451, entitled Simultaneous CT and SPECT Tomography using CZT Detectors.

SPECT Works Well as “Gatekeeper”, says study, anonymous, World Medical Device News, Apr. 02, 2001.

### SUMMARY OF INVENTION

It is desirable to provide a method for enhancing the image quality provided by medical IMAGERY devices. It is particularly desirable to provide a method that permits a user to remove from a medical image a selected biological function and to enhance the resolution of the image of the biological organs of interest.

Accordingly, it is an object of this invention to provide a method for enhancing the quality of medical imaging by removing biological function not of interest and to improve the resolution of the biological function of interest.

It is a further object of this invention to provide a method for enhancing the quality of medical imaging that reconstructs image data to synthesize three-dimensional images.

It is a still further object of this invention to provide a method for enhancing the quality of medical imaging that analyzes for physiological image characteristics.

It is another object of this invention to provide a method for enhancing the quality of medical imaging that segments physiological function to and from an image.

Another object of this invention is to provide a method for enhancing the quality of medical imaging that makes use of acquired physiological kinetic parameters.

Additional objects, advantages and other novel features of the various embodiments of this invention will be set forth in part in the description that follows and in part will become apparent to those skilled in the art upon examination of the following or may be learned with the practice of the invention. The objects and advantages of this invention may be realized and attained by means of the steps and combinations particularly pointed out in the appended claims. Still other objects of the present invention will become readily apparent to those skilled in the art from the following description, wherein there is shown and described various embodiments of this invention, simply by way of illustration of some of the best modes suited to carry out this invention. As will be realized, this invention is capable of other different embodiments, and its several details, and specific steps, are capable of modification in various aspects without departing from the invention. Accordingly, the objects, drawings and descriptions should be regarded as illustrative in nature and not as restrictive.

To achieve the foregoing and other objectives, and in accordance with the purposes of the present invention a variety of steps are provided and described.

### BRIEF DESCRIPTION OF DRAWINGS

The accompanying drawings incorporated in and forming a part of the specification, illustrate a preferred embodiment of the present invention. Some, although not all, alternative embodiments are described in the following description. In the drawings:

FIG. 1 is a set of plots that show the results of computer simulation of this invention.

FIG. 2 is a set of images and plots that show the factor coefficients used in the computer simulations.

FIG. 3 is a set of error reconstruction curves.

FIG. 4 is a set of plots and images showing the results of LS-FADS and PLS-FADS of a cardiac study.

FIG. 5 is a set of images and plots showing the results of 3D LS-FADS and PLS-FADS analysis of the cardiac study.

FIG. 6 is a set of images and plots showing the results of PLS-FADS analysis of a renal study.

FIG. 7 is a set of plots of the factors for which FADS with non-negativity constraints will give a unique solution and the factors used in the computer simulations.

FIG. 8 is a process flow chart of the top-level steps of the present embodiment of this invention.

FIG. 9 is a process flow chart of the detailed steps of the reconstruction step of the present embodiment of this invention.

FIG. 10 is a process flow chart of the detailed steps of the find coefficients and factors step of the present embodiment of this invention.

Reference will now be made in detail to the present embodiments of the invention, examples of which are illustrated in the accompanying drawings.

### DETAILED DESCRIPTION

Radiology is a field of medicine that uses X rays and other means to create images of structures and processes inside the body. These images aid in the diagnosis and treatment of diseases and other disorders. Radiology includes the use of such imaging techniques as computed tomography (CT), fluoroscopy, magnetic resonance imaging (MRI), positive emission tomography (PET) and single photon emission computed tomography (SPECT). Medical procedures that involve ultrasound (high-frequency sound waves) are also considered part of radiology. This invention, although initially developed for use with SPECT, is applicable to use with all medical IMAGERY devices and techniques. The quality of the diagnosis and treatment of diseases and disorders from radiology is directly related to the quality of the IMAGERY produced by the technique being employed. Doctors who specialize in radiology are called radiologists.

Radiological imaging techniques help doctors to diagnose disorders by providing a view of the patient's bones, organs, and other internal structures. For example, a radiograph (X-ray picture) of the leg can reveal a fractured bone, a CT scan of the head can reveal a brain tumor, and a SPECT scan of a patient's chest can reveal heart function. In examinations of certain organs, including the intestines, the urinary tract and the heart, the radiologist may give a substance called a contrast agent to the patient. A contrast agent may be a barium mixture or other low-level radioactive material given to make an organ more clearly seen in the IMAGERY. A contrast agent such as an iodine mixture may be injected into the blood to study arteries or veins. Radiological procedures also aid in the treatment of certain disorders. For example, doctors use fluoroscopy, CT or ultrasound imaging to guide catheters (small tubes) into a patient's body.

Computed tomography (CT), is an X-ray system used to produce images of various parts of the body, such as the head, chest and abdomen. Doctors use CT images to help diagnose and treat diseases. The technique is also called computerized tomography or computerized axial tomograpy (CAT). During a CT imaging procedure, a patient lies on a table that passes through a circular scanning machine called a gantry. The table is positioned so that the organ to be scanned lies in the center of the gantry. A tube on the gantry beams X-rays through the patient's body and into special detectors that analyze the image produced. The gantry rotates around the patient to obtain many images from different angles. A computer then processes the information from the detectors to produce a cross-sectional image on a video screen. By moving the table in the gantry, doctors can obtain scans at different levels of the same organ. They can even put together several scans to create a three-dimensional computer image of the entire body.

Positron emission tomography (PET) is a technique used to produce images of the chemical activity of the brain and other body tissues. PET enables scientists to observe chemical changes in specific regions of a person's brain while the person performs various tasks, such as listening, thinking, or moving an arm or leg. Scientists use PET to compare the brain processes of healthy people with those of people with diseases of the brain. Research is being done to see if it is possible to use these comparisons to identify abnormalities that underlie various brain disorders. These disorders include such mental illnesses as bipolar disorder, schizophrenia, Alzheimer's disease, cerebral palsy, epilepsy and stroke. PET can also help doctors diagnose certain other disorders, including heart disease and cancer. In a PET scan of the brain, the patient's head is positioned inside a ring of camera-like sensors. These sensors can detect gamma rays (short-wave electromagnetic radiation) from many angles. A solution containing glucose bound to a harmless amount of a radioactive substance is injected into a vein. This radioactive labeled glucose mixes with the glucose in blood and soon enters the brain. The radioactive substance gives off positrons, particles similar to electrons but carrying an opposite electric charge. The positrons collide with electrons present in brain tissue and gamma rays are emitted. The sensors record the points where these rays emerge. A computer then assembles these points into a three-dimensional representation of the emitting regions. This representation is displayed on a video screen as cross-sectional “slices” through the brain. Colors in a PET image show the rate at which specific brain structures consume the glucose. The rate of glucose construction indicates how active these structures are doing a particular task.

SPECT is similar to PET but uses a rotation single photon emission and detection device and is useful for observing the “real-time” function of organs.

The Radiologists often desire to uncover or remove certain biological functions or artifacts from the produced IMAGERY in order to better view the organs and tissue of interest. For example, one of the major problems associated with technetium-Tc-99m teboroxime cardiac imaging is the high concentration of activity in the liver. Previous to this invention, it was often impossible to diagnose defects on the interior wall of the heart because of finite resolution and scatter that causes the images of the infer wall and the liver to overlap. This invention addresses the problem of organ overlap and low resolution by applying an image data correction that accounts for ambiguous solutions in factor analysis using a penalized least squares objective technique, thereby effectively removing the liver activity from the image. Similarly, this invention can be used to address most if not all similar medical IMAGERY problems associated with low image resolution and/or organ overlap.

Factor analysis is a powerful tool that can be used for the analysis of dynamic studies. Traditionally, one of the major drawbacks of factor analysis of dynamic structures (FADS) is that the solution is not mathematically unique when only non-negativity constraints are used to determine factors and factor coefficients. In this invention, a method to correct for ambiguous FADS solutions has been developed. A non-ambiguous solution is obtained by constructing and minimizing a new objective function. The most common prior method consists of a least squares term that when minimized with non-negativity constraints, forces agreement between the applied factor model and the measured data. In this invention, the objective function is modified by adding a term that penalized multiple components in the images of the factor coefficients. Due to non-uniqueness effects, these factor coefficients consist of more than one physiological component. The method of this invention was tested on various computer simulations, an experimental canine cardiac study using 99m-Tc-teboroxime, and a patient planar 99m-Tc-MAG(3) renal study. The results of these studies show that the technique of this invention works well in comparison to the “truth” in computer simulations and to the region of interest (ROI) measurements in the experimental studies.

Factor analysis of dynamic structures (FADS), which uses a factor model of the dynamic data, is a semi-automatic technique that is used for the extraction of time activity curves (TACs) from a series of dynamic images. The mixture analysis method is another application of the factor model to dynamic data. In the mixture analysis method pixel-wise time activity curves (TACs) are approximated by using a linear combination of underlying sub-TAC's. One important difference between FADS and mixture analysis is that FADS extracts physiological TACs. More precisely, the obtained curves are interpreted as TACs of a given physiological region and the corresponding factor coefficients define the geometry of that region. In the mixture analysis method, the set of generated sub-TACs does not necessarily correspond to the underlying physiology. Because of these drawbacks, this invention employs FADS techniques. The following discussion includes a description of the use of the FADS as well as the problem of non-uniqueness of the resulting solution.

In the factor model of dynamic data it is assumed that activity in each pixel is a linear combination of factors F with the coefficients of the linear combination defined in matrix C. Using this assumption, the dynamic data A can be written as: (Eqn 1)A=CF +ε with ε being an error in A. The size of A is N×M, where N is the number of pixels in the image and M is the number of dynamic images. The matrix of factors F is P×M and the matrix of the factor coefficients C is N×P, with P being the number of factors. Put simply, it is assumed that the image is built from structures that have the same temporal behaviors. For example, in cardiac imaging such structures are the myocardium, blood pools and liver; and in renal imaging such structures are the kidney cortex, the background, and the ureter.

This FADS method can be used to obtain operator independent results that have advantages over region-of-interest (ROI) measurements, which are obtained when an operator specifies ROIs that correspond to different physiological areas in the image. TACs obtained from ROI measurements may be composites of activities from different overlapping components in the selected ROI. These are the major disadvantages of ROI measurements. On the other hand, this FADS method allows separation of partially overlapping regions that have different temporal behaviors, and therefore enable the extraction of TACs that correspond to those regions.

The FADS procedure usually consists of an orthogonal analysis of the dynamic sequence followed by an oblique rotation. The oblique rotation imposes non-negativity constraints on the extracted TACs (factors) and the extracted images of those factors (factor coefficients). Although the oblique rotation with non-negativity procedure yields reasonable results, they are not unique and depending on the dynamic study under consideration, the achieved solutions may appear different than the “truth.” To explain non-uniqueness of the factor model, consider a data set with two factors. Using equation 1, the data are A=C(1)F(1)+C(2)F(2), where C(1) and C(2) are the factor coefficients for factors F(1) and F(2) respectively. The above equation can be rearranged to A=[C(1)+aC(2)]F(1)+C(2)[F(2)−aF(1)] with a being some constant. If only non-negativity constraints are used then the factor coefficients C(1)+aC(2) and C(2) and factors F(1) and F(2)−aF(1) describe the same data set A as do the factor coefficients C(1) and C(2) and factors F(1) and F(2) as long as C(1)+aC(2) and F(2)−aF(1) are non-negative.

As can be seen in the above example, it is straightforward to construct an additional set of factor coefficients and factors from the existing set, as long as conditions C(1)+aC(2)>=0 and F(2)−aF(1)>=0 are satisfied. This example illustrates the non-uniqueness problem for two factors, but similar non-uniqueness considerations apply to a model with more factors. The severity of the non-uniqueness artifacts depends on the TACs of the physiological components; the non-uniqueness effects can be serious in one use and nearly non-existent in another. For a detailed mathematical analysis and more discussion on these effects, the reader is directed to “Factor Analysis with a priori Knowledge—Application in Dynamic Cardiac SPECT,” Phys.

Med. Biol., vol. 45, pp. 2619-2638, 2000. Non-uniqueness can be a serious drawback to this FADS method.

To correct for non-uniqueness, additional a priori information about the data being analyzed can be used. Information about the spatial distribution of the factor coefficients can be used as a prior data point. For example, the user may be required to specify a region in the image (such as pure background or pure blood) where only one component is present. Methods that use a priori information cannot be used generically, they are designed to work only for specific kinds of dynamic studies. Another way to correct for non-uniqueness is to use the maximum entropy principle. A further approach to correcting ambiguous solutions uses a post-processing technique applied to the solution of the non-unique FADS. However, this approach also uses a priori information about the spatial distribution of factors in cardiac imaging. This technique has been applied to Tc-99m-teboroxime cardiac imaging. Another example of correcting for non-uniqueness can be found in mixture analysis in which unitary constraints have been used to improve the estimation of the background component, thereby enabling other components to be resolved.

In this invention a factor analysis method is used that does not require orthogonal analysis. This method does not use any a priori information and is not restricted to a specific type of imaging. This method can be applied to any medical dynamic sequence of images. This method involves using the penalized least squares objective function to uniquely (to within P scale factors) and accurately extract factors and factor coefficients.

There are three terms in the objective function. One term is the least squares term, which forces agreement between the acquired data and the applied factor model. The second term imposes the non-negativity constraints on the factors and the images of factor coefficients. The third term makes the result of the minimization of the objective function unique by minimizing the products between the factor coefficient images. The rationale behind the choice of the third term will be given in the following section of this description. This method was tested on computer simulations. It was also used to analyze a canine 99m-Tc-teboroxime cardiac study and a patient 99m-Tc-MAG₃ renal study.

The least squares (LS) objective, f(LS), is a Cartesian norm between measured data and the factor model described by:

f(LS)[C,F]=Sum from i=1 to N of (Sum from t=1 to M of (Sum from p=1 to P of (C(i,p)F(p,t)−A(i,t))²)); (Eqn. 2)

where F(pt) is the estimate of the pth factor and t is an index in time. C(i,p) is the ith pixel of the estimate of the pth factor coefficient image. A(it) represents the value of the measurement data (dynamic sequence) at the ith pixel in the tth time frame. If C and F are to be physiologically meaningful they must be non-negative. To impose the non-negativity of estimates C and F, the LS objective is modified by the term f(neg)(C,F) defined as:

f(neg)[C,F]=sum from i,p=1 to N,P of H(C(i,p)+sum from t,p=1 to K,P of H(F(p,t)); (Eqn. 3)

where

H(x)=ax² for x<0; and 0 for x>=0. (Eqn. 4)

with a being a penalty constant. By minimizing f(LS(C,F)+f(neg)(C,F), results similar to a standard FADS with oblique rotation and non-negativity constraints are obtained. The least squares method with non-negativity constraints will be referred to as the LS-FADS method. Non-negativity alone is not enough to guarantee that each factor coefficient image corresponds to a single physiological region—by physiological region we mean the region in the image that has the same temporal behavior. For example, in cardiac imaging such physiological regions are the left ventricle blood pool, right ventricle blood pool, liver, and myocardial tissue (if there is no abnormal uptake in the heart muscle due to infarctions).

Images of the factor coefficients obtained using FADS should correspond to the images of different physiological regions. Ideally, it is expected that in each factor coefficient image only one physiological region will be present. However, due to the non-uniqueness effect, each of the obtained images can be a linear combination of physiological regions in the image. In other words, each coefficient image acquired using non-unique FADS may be a mixture of multiple true physiological components (for more mathematical details and derivation, the reader is directed to “Factor Analysis with a priori Knowledge—Application in Dynamic Cardiac SPECT,” Phys. Med. Biol., vol. 45, pp. 2619-2638, 2000. In order to reduce the amount of mixing this invention adds to the objective function a term that is a dot product of the normalized coefficients:

f(uni)[C]=b(sum from p=1 to P of sum from q=p+1 to P of sum from i=1 to N of [C(i,p)/sqr root(sum from j=1 to N of C²(j,p)]x[C(i,q)/sqr root(sum from j=1 to N of C²(j,q)] (Eqn.5)

A total objective function f(PLS)=f(LS)+f(neg)+f(uni) will be called the penalized least squares objective function of this invention. Minimization of equation 5 will reduce the amount of overlap between different coefficient images and therefore will minimize the amount of mixing between the different components. It is preferred in f(uni) that the values of the image coefficients be normalized in such a way that the scaling of C does not affect the value of f(uni). In equation 5, the values are normalized by the term square root of [sum, from j=1 to N, of C²(j,p)] in the denominator. Without this normalization, f(uni) could be scaled to 0 by scaling C to 0. Such scaling of C is allowed in the factor model since there is a multiplicative relation between C and F.

Therefore, by scaling C by a constant, x, matrix F is scaled by 1/x and the model expressed by equation 1 holds. This scaling creates additional degrees of freedom that are not constrained by the objective function.

The coefficient images that result from the minimization of f(uni) should have simple structures that correspond to single physiological regions. The lower value of f(uni), compared with f(LS)+f(neg) was chosen so that the non-negativity of the results imposed by f(neg), as well as agreement with the data guaranteed by f(LS) are not compromised by the addition of the f(uni) term to the objective function. The constant b is applied in equation 5 to adjust the strength of the non-uniqueness penalty. The optimal value of b was investigated in computer simulations for different levels of noise.

A number of factors P were chosen before the minimization was performed. An orthogonal singular value decomposition of the dynamic data is used to examine magnitudes of the singular values. Then based on the number of the singular values, which were well above the noise level, the appropriate number of components were chosen.

The inventors have found that the algorithm is not sensitive to the selection of a starting point. For all optimization results, described here, the same starting point was used. All images of factor coefficients were initialized with a value of 1. Since optimization is done by a conjugant gradient method, and the values of C were initialized by a constant, the factors were initialized with linearly independent functions. Therefore, to avoid stalling the optimization, any row of F can not be a linear combination of the other rows. Also, the values of F are chosen such that the resulting initial values of the matrix A=CF has approximately the same order of magnitude as the values in the matrix A of the dynamic data being analyzed.

After the initialization, a conjugate gradient method is used for the minimization. In each iteration a gradient of the objective function ∇f(PLS)=[∂f(PLS)/∂C, ∂f(PLS)/∂F] is calculated analytically using equations 2, 3 and 5. The function is then minimized in the conjugate direction of the gradient using the Brent method. The iterations are terminated when the relative change in the objective function in one iteration is less than 10⁻⁶. Depending on the size of the data being studied, 40-150 iterations are required. In terms of the speed, the process takes approximately 20 seconds to converge, using a SUN Ultra 1 computer system, for the 2D data sets.

The method used for selecting b is to adjust the value of the penalty parameter after every few iterations of the conjugate gradient algorithm so that the ratio of f(uni)/[f(LS)+f(neg)] is equal to 0.1. The value of a is typically large. Its value is not critical when the algorithm is used to estimate physical (no negative values) solutions.

After the optimization, the results and matrices C and F are re-scaled. That is, the coefficients C are scaled so that all values of the coefficients are in the range from 0 to 1. This scaling is done separately for each column in C by finding the approximate maximum value of each column by averaging the 10 pixels with the highest coefficients, then dividing all coefficients of a given column by this maximum. Naturally, the corresponding rows in F are scaled by the reciprocal of this maximum in order for equation 1 to hold.

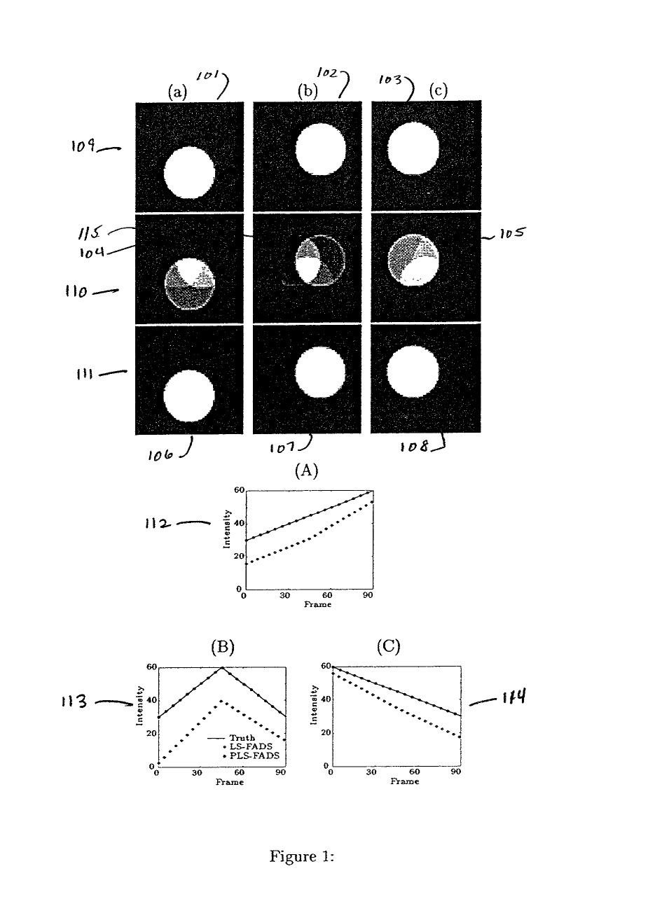

Computer simulations have been performed to test the performance of the process of this invention. A simple dynamic sequence was created from the three objects 101, 102, 103, shown in the first row 109 of FIG. 1. The intensities of each object were changed according to the curves 112, 113, 114. A total of 90, 64×64 pixel images were generated. Noise was not added to these images.

A more realistic computer simulation was also performed. A slice of the MCAT phantom was used for this simulation. Three components in the image were simulated: the right ventricle blood pool (RV) 201, the left ventricle blood pool (LV) 202, and the myocardial tissue (TI) 203. The presence of vascular activity in the myocardial tissue was simulated by adding 10% of LV activity to the tissue, 204, 205, 206. The simulated curves 210, 211, 212 are presented as “truth” for the RV, LV and tissue respectively. A previously developed model and its parameters, was used to create the simulated curves 210, 211, 212. Partial volume effects were simulated by smoothing the images of MCAT phantom components so that the neighboring structures partially overlap by 2-3 pixels, 207, 208 209.

A dynamic sequence of 180, 20×20 pixel images was created and analyzed by least squares FADS. Dynamic sequences with normally distributed noise (variances equal to 15%, 25% and 35% of the value of the mean) were generated from a noise-free sequence. The selection of normally distributed noise for the simulation was based on the fact that the distribution of noise in reconstructed images is unknown, and it is assumed that normally distributed noise gives a reasonable approximation. For each computer simulation with noise, one hundred noise realizations were used.

The accuracy of the curve estimates was measured using a measure D, which is the total distance from the “true” LV and RV curves to the estimates of LV and RV curves obtained using the PLS-FADS method of this invention. This measure is defined as:

D=Sum, from p=LV,RV ofSum, from t−1 to M of absolute value of [F(p,t)−F′(p,t)]/[sum, from p′=LV,RV, of sum, from t′−1 to M of F(p,′t) (Eqn. 6)

where F′ is the “true” factor and F is an estimate of that factor obtained via the PLS-FADS method of this invention. The measure D was calculated over the LV and RV only. The tissue component was not taken into account during the calculation of the measure D because the error calculated by D of the tissue curve occurs mainly as a result of the ambiguity over how much simulated vasculature in the tissue is present in the tissue curve obtained by non-unique LS-FADS. Since this ambiguity is not directly connected to the non-uniqueness effects, when considering the LV and RV components alone, the effects of the non-uniqueness of the factor model was only taken into account in this simulation.

Several experimental studies were performed. Data from a 99m-TC-teboroxime canine study was analyzed. A three-detector IRIX scanner (Marconi Imaging Systems, Inc., of Cleveland, Ohio, USA) was used to acquire transmission and emission projection data. The camera acquired 120 projections every 6 seconds for approximately 18 minutes. The 179 dynamic images were reconstructed using 25 iterations of the ML-EM technique with attenuation correction. The reconstructed 3D images were then reoriented to obtain short-axis slices of the heart. Factor analysis methods of this invention were applied to a 2D, 11×11 pixel region that encompassed a short axis slice of the myocardium. A 3D analysis in which a series of 179 (6 slices, 11×11 pixels) images were analyzed as a 3D data was also performed.

Patient data from a planar 99m-Tc-MAG₃ renal study were also analyzed. The data was acquired using an eCam system (Siemens, Hoffman Estates, Ill., USA). The patient rested in a supine position as data was acquired by the detector in a 128×128 pixel matrix. The 300 dynamic images were acquired every 5 seconds. FADS was applied to an 18×20 pixel region that encompassed the right kidney. Only small regions of the image were investigated since incorporation of the larger regions would require increasing the number of factors to adequately represent the data, which would decrease the accuracy of the obtained factors that we were interested in.

ROI measurements were performed in both experimental studies. In the 2D canine cardiac study the ROIs spanned 4 pixels. They were automatically determined using FADS results that identified pixels with the highest values of factor coefficients (matrix C) that corresponded to the LV, RV, and tissue. Such semi-automatic selection of ROIs decreases the amount of errors caused by overlapping of neighboring factors. It is also user independent. For the 3D cardiac and renal patient study the ROIs spanned 10 pixels, and the method for determining the locations of the ROIs was the same as in the 2D cardiac study.

The change of contrast in the image of the factor coefficients between region 1 in the image and region 2 in the image was measured using the following definition ⊂:

œ¹₂=[C(1)−C(2)]/C(1) (Eqn. 7)

where C(1) and C(2) are average values of 3 pixels from a given region in the factor coefficient image C for regions 1 and 2, respectively.

The following results of the use of the method of this invention were observed. The conjugate gradient algorithm is very robust. Unconstrained degrees of freedom due to scaling does not hinder convergence of the method. All results are presented in the forms of images that correspond to images of factor coefficients and curves that correspond to factors. Since the results were rescaled after the reconstruction, as previously described, all images are in the range from 0 to 1, so the same gray scale is used for all of them. The results of using this method, the LS-FADS, are presented in FIG. 1. The images of factor coefficients obtained using this method are shown in the second row 110 as images 115, 104, 105. In each image, all of the objects can be seen, due to the non-uniqueness effects. The factors obtained using the LS-FADS method are shown in curves 112,113, 114. They each show substantial disagreement with the simulated factors. The third row 111 corresponds to the images of factor coefficients obtained using the PLS-FADS method. Factors obtained by both methods are presented in FIGS. 1(A)112, (B) 113,(C) 114 and compared to simulated curves. Both, the images and the curves obtained using the PLS-FADS method of this invention show very strong agreement with the simulated objects.

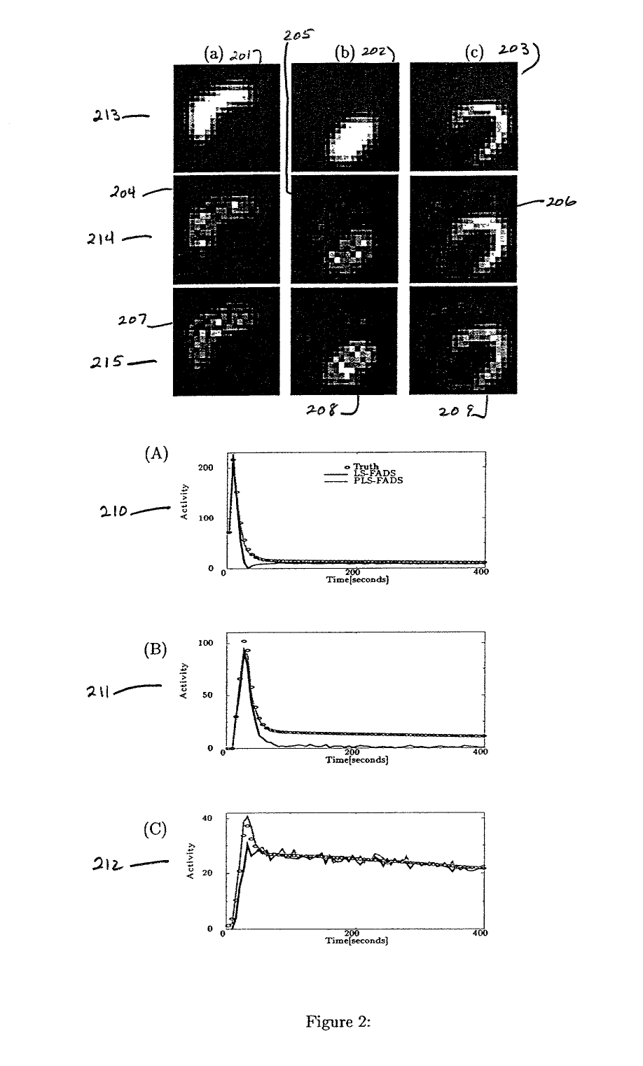

The results of the more realistic simulation are presented in FIG. 2. The first row 213 of images 201, 202, 203 presents the factor coefficient images used to simulate teboroxime uptake in the heart. The second row 214 of images 204, 205, 206 corresponds to factor coefficient images obtained using the non-unique LS-FADS method. Non-uniqueness artifacts similar to those shown in previous computer simulations are clearly visible. For instance, in the image of the LV, some of the RV can be seen, and in the image of the tissue the LV is clearly visible. Application of the penalized objective reduces these artifacts and creates a much better agreement between the factors obtained through the FADS methods and the “true” factors, as can be seen in FIGS. 2(A) 210, 2(B) 211, and 2(C) 212.

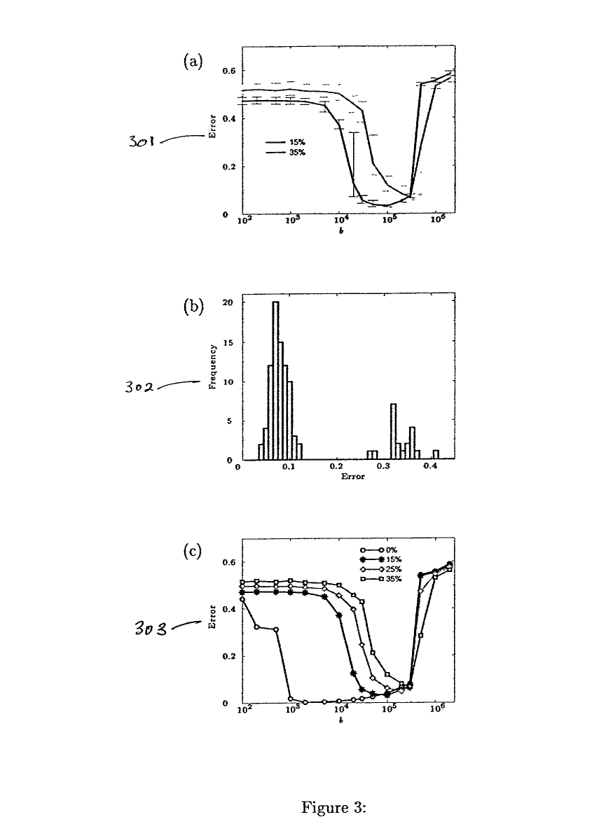

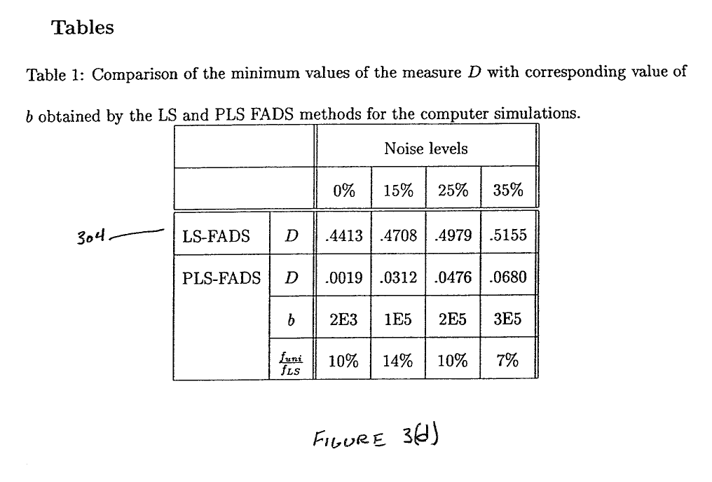

The value of the error measure D is plotted vs. the strength parameter b in FIG. 3(a) 301. For the low values of b (less than 10⁴) reconstructions yield larger errors (high values of D) because the non-uniqueness correction has little effect on the final results since the value of b is low. D slowly decreased when FADS was applied with b˜5×10³. Further increases of b to 5×10⁵ make D rapidly increase because the domination of the term f(uni) in the objective function. High b forces the dot product between the images of the different factor coefficients to be close to zero. The null value of the dot product term in the high b results is achieved by creating sharp edges between components, i.e., the pixels that normally belong to 2 neighboring components, due to the partial volume effect, are forced to be in one or the other of the neighboring structures. The rapid degradation of the results, seen in FIG. 3(a) 301 as a sharp increase of D, is created by further increases of b, which force a negative value on the f(uni). Negative values of f(uni) can be achieved when values of the pixels in one of the images of the factor coefficients reaches slightly negative values. As a result, the non-negativity term is not increased significantly, and at the same time the dot product of this image with other non-negative components causes a negative contribution to f(uni).

In FIG. 3(a) 301, for some values of b the standard deviation of the calculated D is high and the distribution is asymmetric. This finding is illustrated in FIG. 3(b) 302. In the histogram 302 it can be seen that the final value of D for different noise realizations for one value of b is either high or low. This makes the distribution of D high and asymmetric. FIG. 3(c) 303 presents a comparison of the D(b) relationship for different noise levels. It shows that with higher noise the best achieved D is higher and the range of b, for which the non-uniqueness correction works, is narrower.

Table 1, FIG. 3(d) 304, presents the summary of the computer simulation results. It shows that the use of the non-uniqueness penalty greatly improves the value of the measure D. In the table 304, values of the penalty parameter, b and f(uni)/f(LS) are given for the PLS-FADS acquisition of this invention, which derived the best value of D. The table 304 also shows that the ratio of f(uni)/f(LS) remains at approximately the same level, 10%, even though the noise levels change considerably.

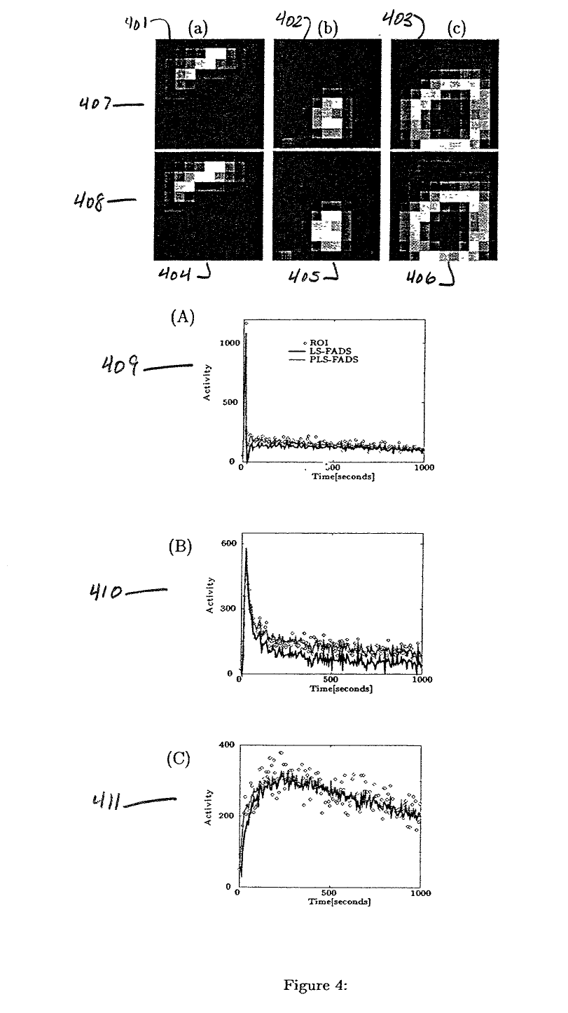

The results of the experimental studies are summarized as follows. FIG. 4 shows a summary of the results of the 2D cardiac canine study. The images 401, 402, 403, 404,405, 406 in FIG. 4 represent factor coefficients for three different factors corresponding physiologically to the RV, LV and the myocardial tissue. The first row 407 displays the results obtained using the LS-FADS method. The second row 408 displays the PLS-FADS results. The contrast is improved in the PLS-FADS images of the LV and tissue (contrast between pixels corresponding to the LV and tissue) in comparison to the images obtained using the LS-FADS method. For the LV coefficient image, c^{-LV}ₜᵢₛₛᵤₑ was 0.79 for the LS-FADS and 0.95 for the PLS-FADS method preferred in this invention. The value of c^{-LV}_{RV} also improved from 0.65 for the LS-FADS method to 0.86 for the PLS-FADS method. In the image of tissue coefficients, c^{-tissue}_{LV} changed from 0.84 to 1.00. FIGS. 4(A) 409, 4(B) 410, and 4(C) 411 show factors obtained using the LS and PLS-FADS methods and the corresponding TACs obtained by ROI measurements. It can be seen that the PLS-FADS factors, used in the preferred embodiment of this invention, agree better with the ROI curves than the factors obtained by the LS-FADS method. Measures D, calculated between the ROI curve and the factor analysis obtained curve, were 0.2874 and 0.1187 for the LS-FADS method and the PLS-FADS method, respectively. It should be noted that the comparison is made to ROI curves, which may be biased for the reasons already discussed, nevertheless, ROI measurements are and continue to be widely used for the extraction of the TACs.

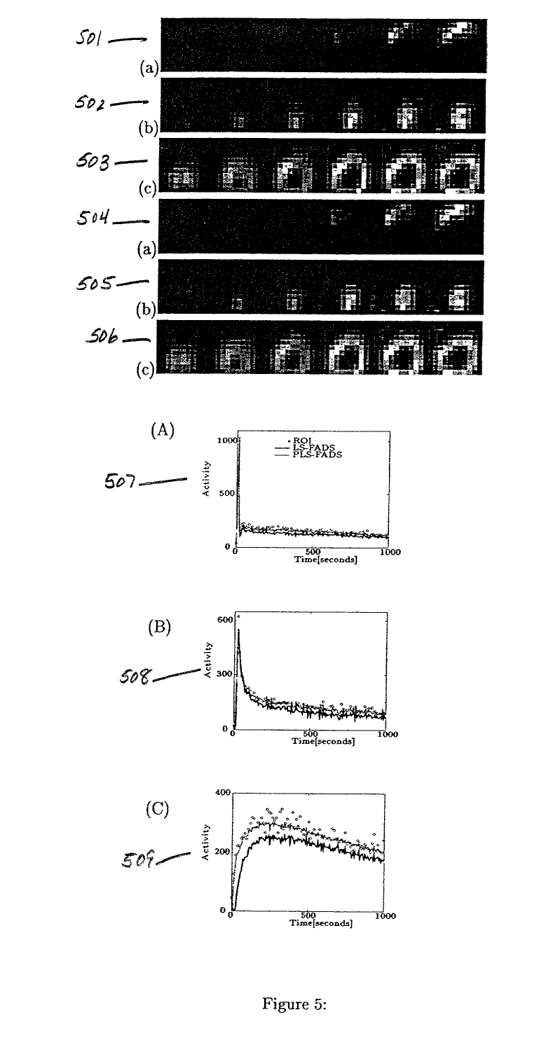

The analysis of the 3D data yields findings similar to those of the 2D analysis. It is noteworthy that the 6th slice in the 3D data set is the same slice studied in the 2D analysis, for which the results are presented in FIG. 4. For the 6th slice in the 3D data set, FADS with the correction for non-uniqueness gave results that agree better with the ROI measurements than FADS without correction (FIG. 5) (D=0.1953 for the LS-FADS and D=0.0736 for the PLS-FADS). This is particularly apparent in the tissue curves of FIG. 5(C) 509. Also, contrast in the images of the factor coefficients of the LV and the tissue obtained by the PLS-FADS method, FIGS. 5(a) 504, 5(b) 505 and 5(c) 506, of the preferred embodiment of this invention, is improved over the results of the LS-FADS method, FIGS. 5(a) 501, 5(b) 502, and 5(c) 503. For the 3D LV coefficient image, c^{-LV}ₜᵢₛₛᵤₑ changed from 0.63 for the LS-FADS to 0.89 for the PLS-FADS method. Also, the value of c^{-LV}_{RV} was better with the PLS-FADS (1.00) method than with the LS-FADS method (0.87). In the image of tissue coefficients, c^{-tissue}_{LV}—changed from 0.98 to 1.00.

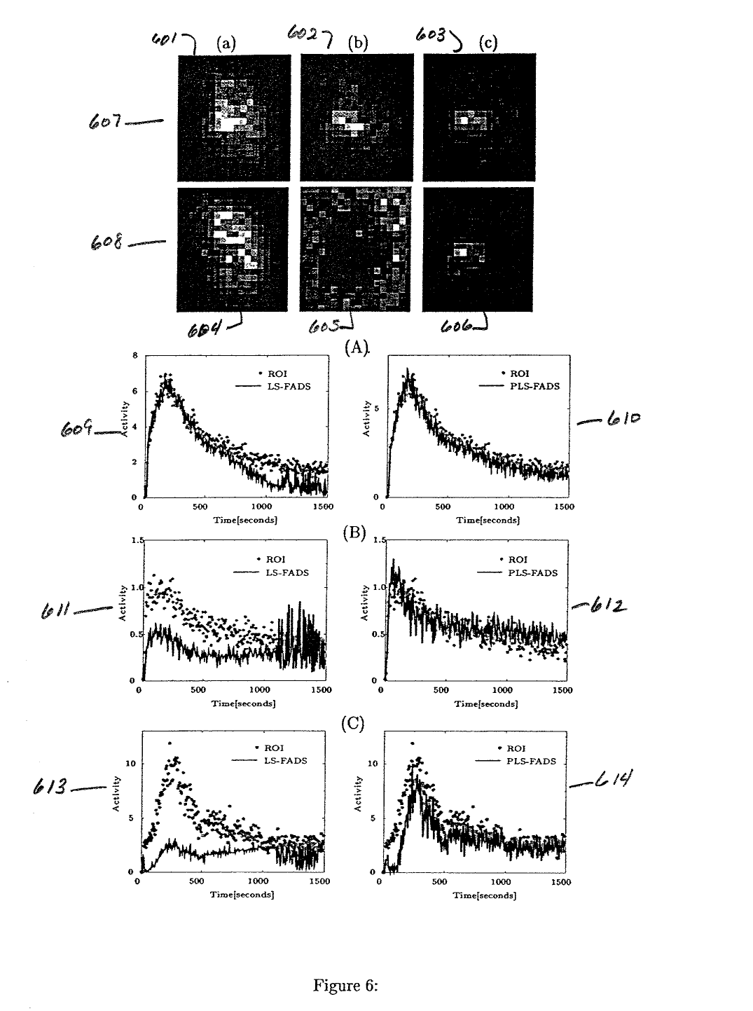

The LS-FADS and PLS-FADS methods were also applied to a patient renal study. Results of the LS-FADS and PLS-FADS analysis, which were applied to the right kidney, are presented in FIG. 6. The top two rows 607, 608 of images 601, 602, 603, 604, 605, 606 present the factor coefficient images for the kidney cortex, background and pelvis/ureter components obtained using non-unique LS-FADS 607 and PLS-FADS 608 respectively. In the LS-FADS results the images have similar structures and overlap considerably. This results in factors that do not agree with the ROI curves. These findings are presented in plots (A) 609, 610; (B) 611, 612; and (C) 613, 614. In the LS-FADS results (region from 1000 to 1500 seconds) the curves appear to be much noisier. This is because the factor coefficient images are similar, which allows the factors to exchange, i.e., the factor increase in one curve is compensated for by decreases in the other factors. This is only possible because the images of the factor coefficients are similar and high noise levels are present. When the PLS-FADS method is applied the obtained curves agree much better with the ROI measurements. The D is calculated using the background and the cortex factors between the ROI curves and the FADS obtained curves decreased from D=0.2554 for the LS-FADS to D=0.1128 for the PLS-FADS method, of the preferred embodiment of this invention. The agreement of background curves is approximate though because the FADS-obtained background image also contains some of the liver component, which can be seen in the coefficient image of the background as increased activity in the upper right corner 606 of FIG. 6(b), second row 608. As a result, the corresponding factor is biased by the liver component. The pelvis curves, although similar in shape, differ considerably due to the fact that in the ROI results there is complete overlap of the cortex and pelvis, whereas in the FADS results, these two different physiological regions are separated.

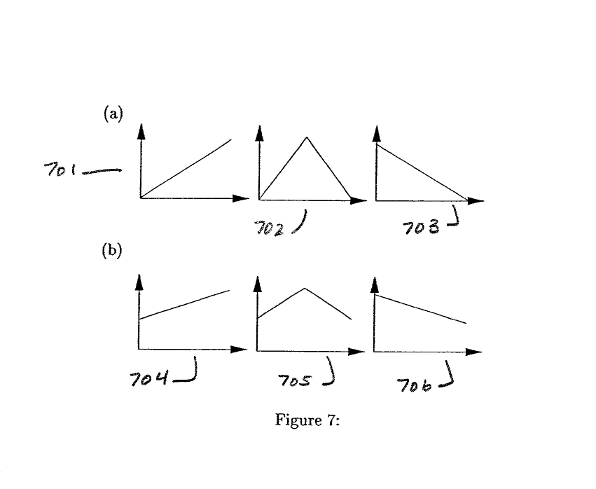

The figures presenting the results from computer simulations, FIGS. 1 and 2, clearly show that the factor coefficient images are mixed when the FADS method with non-negativity constraints is employed. For example, in the FADS obtained images of each component, the other components can be seen. Most of the corresponding factors are completely inaccurate and lie far from the simulated curves—this is especially apparent in FIGS. 1(A) 112, (B) 113 and (C) 114. The example shown in FIG. 1 shows the possible severity of non-uniqueness artifacts. This example, was specifically chosen to show how inaccurate FADS with non-negativity constraints can be. On the other hand, it is possible to construct a different computer simulation in which FADS with non-negativity constraints give a unique answer. For example, if the factors used are the same as the ones presented in FIG. 7(a) 701, 702, 703, FADS with non-negativity constraints will give a unique answer. This is because it is impossible to subtract any of those factors from any others without violating the non-negativity of the factors. This, and the fact that the factor coefficient images also cannot be subtracted from one another without violating non-negativity, guarantees the uniqueness of the FADS results for this example. Conversely, it was shown in the computer simulations that non-uniqueness artifacts were severe when they were applied to the set of factors presented in FIG. 7(b) 704, 705, 706. It can be concluded that the non-uniqueness effects have a significant impact on the results of FADS, and the severity of the non-uniqueness strongly depends on the study under consideration.

The process and method of this invention introduces unconstrained degrees of freedom due to arbitrary scaling of the factors and factor coefficients. However, this does not affect convergence of gradient based optimization because directional derivatives of the objective function in directions associated with the scaling ambiguity are zero.

The most problematic issue in the method is the selection of the appropriate value of the non-uniqueness penalty parameter b. FIG. 3(a) 301 shows that for the analyzed computer simulation of teboroxime uptake, b needs to be larger than for a threshold value in order for the correction to work optimally. Obviously, for alternative sensors and procedures alternative values for b would be derived, typically using the techniques described herein. The improvement in accuracy of the curve extraction, in this embodiment, by PLS-FADS is very rapid. As can be seen in the histogram of FIG. 3, 302, with the same noise level—but different noise realizations, non-uniqueness correction either works well (low values of D) or does not work well (high values of D). The value of b should also be less than an upper threshold, above which extracted factors and factor coefficients are less accurate, because the non-uniqueness term dominates in the objective function and the results of the factor model no longer match the analyzed data. Thus, b should be in the range between the lower and upper thresholds. As seen in FIG. 3(c) 303 the upper threshold remained the same and the lower threshold changed as noise levels changed. However, the minima of D are observed to be such that the value of f(LS)+f(neg) is approximately 10 times larger than f(uni), as can be seen in Table 1 304. This fact was used to select b for the experimental studies. Although, the mis-selection of b is a potential problem it is encouraging that (as shown in the computer simulation), the range of “good” b values is wide and, depending on the noise, varies typically from one to two orders of magnitude. Also, encouraging is the fact that when b was selected in the same manner as in the teboroxime study it proved equally useful for the completely different renal study, see FIG. 6.

This strategy used for selecting b, as described above, has proved to be successful. It works not only in 99m-Tc-teboroxime cardiac imaging and renal imaging as shown in this description, but also for other dynamic studies not discussed here. It worked well for a patient 99m-Tc-teboroxime cardiac study with four components (the LV, RV, tissue and liver) a two component PET (positron emission tomography) liver FDG study and a dynamic cardiac MRI study.

When using PLS-FADS, the dot product between the factor coefficient images is minimized without violating the non-negativity constraints, or violating equation 2, because the constant b in equation 5 is small. This minimization prevents mixing and creates perfect agreement between the PLS-FADS results and the simulated data (FIG. 1 and FIGS. 1(A) 112, (B) 113 and (C) 114. These effects can also be seen in the experimental data. In the image of the left ventricle in FIG. 4(b) 402 some of the components of the right ventricle and the tissue can be seen. Additional components in this image are removed when PLS-FADS is used 405, see FIG. 4(b) second row 408.

The same effect can be seen in the images of the tissue components. The tissue image 403, FIG. 4(c) first row 407, is biased by the LV and the RV. When PLS-FADS is used the LV and RV contamination is removed from the image of tissue factor coefficients, which increases the contrast in this image 406, FIG. 4(c) second row 408, in comparison to the tissue image obtained using the LS-FADS method. Significantly better agreement is achieved between the results of factor analysis and the ROI measurements when the penalized objective function is used. This is especially true for the LF, FIG. 4(B) 410 and for the RV, FIG. 4(A) 409 curves.

Different non-uniqueness effects can be seen in the results of FADS for the 3D data set than can be seen in the FADS results for the 2D data set. The tissue curve obtained using the LS-FADS method is much different than the curve obtained by the ROI measurements, FIG. 5(C) 509. This disagreement was corrected by applying the non-uniqueness correction, PLS-FADS. A disagreement in the tissue curves obtained by the LS-FADS arises because the LV component completely underlies the myocardial tissue due to the existence of vasculature in the heart muscle. Therefore, the amount of vasculature contained in the tissue curve in the results of the non-unique FADS acquisition is ambiguous. Due to this ambiguity in the 2D data set the tissue curve obtained by LS-FADS is close to the ROI curve, FIG. 4(C) 411, and for the 3D data set it is not, FIG. 5(C) 509. Obviously, the tissue ROI curves represent the tissue curve with the addition of a vasculature component. The PLS-FADS removes the disagreement because the non-uniqueness correction minimizes the overlap between the factor coefficients, so that the myocardial tissue and the LV vasculature of the heart muscle are treated as one component, since spatially they occupy the same space. As a result, the PLS-FADS tissue curve is similar to the one obtained by ROI measurements, FIGS. 4(C) 411 and 5(C) 509. This can also be seen in the results of the computer simulations of FIG. 2.

Some new non-uniqueness artifacts can be seen in the renal study where the components are exchanged, thereby increasing the noise in the acquired factors, FIG. 6 (C) 613, 614. This is because the images of the factor coefficients are similar. This similarity is removed when the penalty is used in the objective function and the exchange effect is removed in the results of the PLS-FADS. In the renal study there is a partial overlap between the pelvis component and the cortex. The PLS-FADS method of this invention separates these regions, FIGS. 6(b) 605, 6(c) 606. In the factor curve that corresponds to the pelvis, a delay can be seen between the maximum activity in the cortex and the maximum activity in the pelvis. Activity in the pelvis is zero during the first 2 minutes after injection. These effects cannot be seen on ROI curves because of the overlap between the pelvis and the cortex. Therefore, the ROI curve that corresponds to the pelvis is non-zero from the beginning.

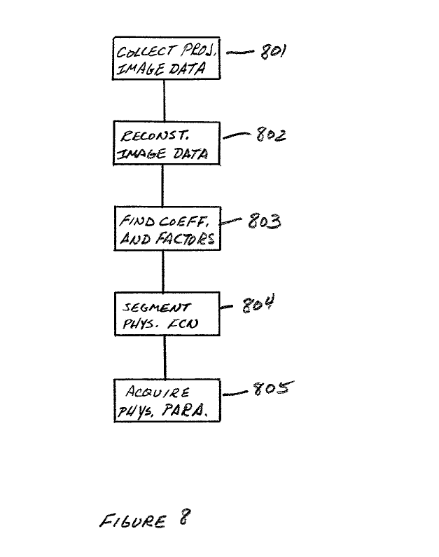

In FIG. 8 the top level steps of the method or process of this invention are shown. Using any of the available medical imaging devices, including but not necessarily limited to computed tomography (CT), fluoroscopy, magnetic resonance imaging (MRI), positive emission tomography (PET), single photon emission computed tomography (SPECT), and ultrasound projection image data is collected 801. The collected image data is reconstructed 802. Typically, this reconstruction creates the data for 3D images, although in alternative embodiments, 2D image data may be created in this step. The 3D images are formed in short intervals of time, thereby providing visualization of the changes in the images. Coefficients and factors are found 803 by analyzing pixels for physiological image characteristics. Physiological functions are segmented 804 from and/or to the image data and physiological kinetic parameters are acquired 805. In alternative embodiments of the invention, depending on the source, type and intent for use of the data, steps 804 and/or 805 may be skipped.

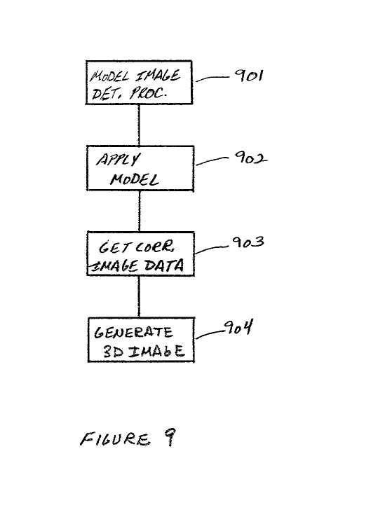

FIG. 9 shows the detailed steps of the reconstruction step 802 of the present embodiment of the invention. The physics of the image detection process, related to the image source device, are modeled 901in order to determine critical characteristics such as attenuation, scatter and detector response. The model is applied 902 to the projected image data to get 903 corrected 3D image data. In some, but not all, embodiments, a 3D image is generated 904 from the corrected 3D image data.

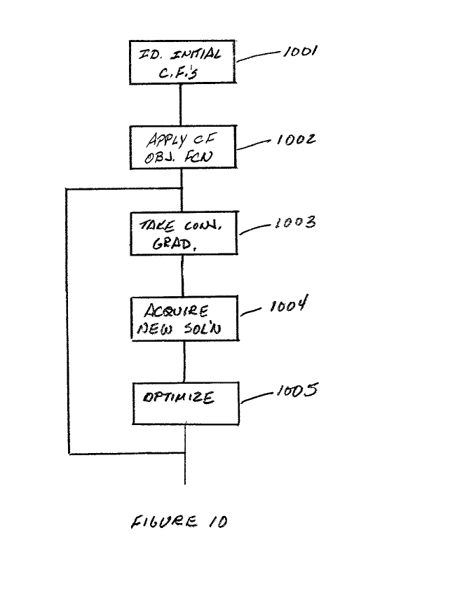

FIG. 10 is a detailed flow diagram of the find coefficients and factors step 803. Initial coefficients and factors are identified 1001. The coefficients and factors are applied 1002 to the objective function. Typically, in the present embodiment of the invention the objective function is defined by the equations previously identified as equations 2, 3, 4 and 5. The gradient of the resulting function is taken 1003 to acquire 1004 a new solution. The solution is numerically optimized 1005, typically in the present embodiment by using a conjugant gradient, although other numerical methods for optimization may be substituted in some embodiments without departing from the concept of this invention. Steps 1003 and 1004 are repeated until the numerical step size has adequately approached zero.

The foregoing description of the present embodiments of the invention has been presented for the purposes of illustration and description of the best mode of the invention currently known to the inventors. It is not intended to be exhaustive or to limit the invention to the precise form disclosed. Obvious modifications or variations are possible and foreseeable in light of the above teachings. This embodiment of the invention was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when they are interpreted in accordance with the breadth to which they are fairly, legally and equitably entitled.

1. A method for processing visual imagery, comprising:
(A) collecting image data;
(B) reconstructing said collected image data;
(C) finding coefficients and factors; and
(D) applying physiological data to said image data.

2. A method for processing visual imagery, as recited in claim 1, wherein said applying physiological data further comprises segmenting physiological function from said image data.

3. A method for processing visual imagery, as recited in claim 1, wherein said applying physiological data further comprises segmenting physiological functions to said image data.

4. A method for processing visual imagery, as recited in claim 1, wherein said applying physiological data further comprises acquiring physiological kinetic parameters.

5. A method for processing visual imagery, as recited in claim 1, wherein said finding coefficients and factors further comprises analyzing pixels for physiological image characteristics.

6. A method for processing visual imagery, as recited in claim 1, wherein said reconstruction further comprises:
(1) modeling an image detection process to generate a model; and
(2) applying said model to projected data.

7. A method for processing visual imagery, as recited in claim 6, wherein said applying said model to projected data further comprises generating 3D image data.

8. A method for processing visual imagery, as recited in claim 6, further comprising:
(3) generating 3D image data for display.

9. A method for processing visual imagery, as recited in claim 1, wherein said finding coefficients and factors further comprises:
(1) identifying initial coefficients and factors;
(2) applying said initial coefficients and factors to an objective function;
(3) performing a conjugate gradient on said function to find a result; and
(4) numerically optimizing said result.
